(19) United States
(12) Patent Application Publication
(10) Pub. No.: US 2023/0219328 A1
(43) Pub. Date: Jul. 13, 2023

(54) HOT-FILLABLE ARTICLES MADE FROM MULTILAYERED THERMOFORMABLE FILM AND SHEET

(71) Applicant: Eastman Chemical Company, Kingsport, TN (US)

(72) Inventors: Ian David Fearnley, Darlington (GB); Marc Alan Strand, Kingsport, TN (US); Katherine Augusta Hofmann, Kingsport, TN (US)

(73) Assignee: Eastman Chemical Company, Kingsport, TN (US)

(21) Appl. No.: 17/996,005

(22) PCT Filed: Apr. 13, 2021
(86) PCT No.: PCT/US2021/027049

§ 371 Date: Oct. 12, 2022

Related U.S. Application Data
(60) Provisional application No. 63/009,156, filed on Apr. 13, 2020.

(51) Int. Cl. B32B 27/08; B32B 27/36; B32B 7/027; B65D 65/40; C08L 67/02

(52) U.S. Cl. CPC B32B 27/08; B32B 7/027; B32B 27/36; B65D 65/40; C08L 67/02; B29C 51/10; B32B 2250/244; B32B 2307/412; B32B 2307/732; B32B 2439/60; B32B 2439/62; B32B 2439/70; B32B 2439/80; B32B 2509/00; B32B 2509/10; B32B 2571/00; C08L 2203/16; C08L 2203/30; C08L 2205/025

(57) ABSTRACT

The present disclosure relates to hot-fillable articles made from multilayered thermoformable film and sheet comprising polyester and copolyester compositions which comprise residues of terephthalic acid, 1,4- cyclohexanedimethanol (CHDM), 2,2,4,4-tetramethyl-1,3-cyclobutanediol (TMCD), ethylene glycol (EG), and diethylene glycol (DEG), in certain compositional ranges having certain advantages and improved performance properties.

### FIELD OF THE INVENTION

The present disclosure relates to hot-fillable articles made from multilayered thermoformable film and sheet comprising polyester and copolyester compositions which comprise residues of terephthalic acid, 1,4-cyclohexanedimethanol (CHDM), 2,2-dimethylpropane-1,3-diol (neopentyl glycol or NPG), 2,2,4,4-tetramethyl-1,3-cyclobutanediol (TMCD), ethylene glycol (EG), and diethylene glycol (DEG), in certain compositional ranges having certain advantages and improved performance properties.

### BACKGROUND OF THE INVENTION

Recyclability and environmental issues are driving a move away for PVC and styrene in hot-fillable containers. PET or lightly modified PET has become a material of choice for applications were recycling is of key importance. However, for most hot-fill food packaging applications PET is not suitable because it cannot hold up to the required temperatures. There is a commercial need for recyclable thermoformed articles produced from copolyester thermoplastic materials that are clear, tough, and hot-fillable.

Applicants have developed multilayered articles that are useful in hot-fill applications. In one embodiment, the multilayer article has an A/B/A structure. The A layers are high temperature copolyester resins that contain glycols such as CHDM and TMCD. In one embodiment, the A layers comprise different copolyester resins. In another embodiment, the A layers comprise the same copolyester. The B layer is a PET or lightly modified PET. The A and B layers of the present disclosure are co-extrudable. The multilayer structures of the present disclosure pass the hot fill requirements as well as the requisite drop test parameters. The multilayer structures are also visually clear with low haze values. In one embodiment, the multilayer structures disclosed herein are clear, hot fillable tri-layer structures, that also meet the RIC-1 requirements for recyclability into a PET recycle stream. In some embodiments, the combinations of the A and B layers enable recyclability of the structures and articles in a PET recycle stream. Additionally, in one embodiment, during processing, the edge trim and other scrap material left over in the thermoforming process can be reclaimed and reused in the B layer without causing haze in the total structure. Current regulations and consumer preferences are driving plastic packaging materials away from highly modified copolyesters toward materials that are considered more compatible with the PET recycle stream.

The state of California has defined Resin Identification Code - 1 (PETE) as a material that is greater than 90% PET and must have a crystalline melting point between 225° C. and 255° C. Typically, highly modified copolyesters do not fit this definition. Thus, there is a need to develop RIC-1 compatible materials that are suitable for hot-fill applications. Successful materials in these applications must have enough toughness to withstand a drop test when full of liquid. Often, the drop impact strength is obtained by the selection of certain glycols such as CHDM or TMCD. The California definition of RIC-1 significantly limits the amount of CHDM, TMCD or other comonomers that can be used. Thus, the polymers typically used in these applications are PET formulation with up to 10% modification. These materials fit the California definition of RIC-1.

The RIC-1 (resin Identification code 1, for PET like materials) has stated that all RIC-1 acceptable materials must be at least 90% by weight PET. This includes the use of TPA or DMT with EG. RIC-1 materials must also have a crystalline melting point between 225° C. and 255° C. Pure PET has a melting point close to 255° C. Highly modified copolyesters typically do not satisfy the 90% PET requirement, and they do not have a crystalline melting point in the required range. Thus, there is an unmet commercial need for materials that satisfy both the RIC-1 requirements and that can withstand the hot-filling temperatures, and provides the toughness for good drop impact strength properties needed for hot-fill applications.

Applicants have discovered a formulation that is both suitable for RIC-1 applications and provides good melt strength and good drop impact properties. The present disclosure addresses this long felt commercial need for thermoformed articles produced from copolyester thermoplastic materials that are clear, tough, hot-fillable, and that can be recycled in a PET recycle stream.

### BRIEF SUMMARY OF THE INVENTION

There is a commercial need for recyclable thermoformed articles produced from copolyester thermoplastic materials that are clear, tough, hot-fillable and recyclable.

To be considered recyclable, the articles must be transformable at the end of life back into usable polymeric material. Currently, poly(ethylene terephthalate) (PET) is the largest volume thermoplastic with an existing and well-established mechanical recycling stream.

Recycling of post-consumer PET is a complex process that involves separating opaque, colored and transparent components from each other as well as from containers made from different materials (e.g. polyethylene, polypropylene, PVC, etc.). Proper separation is critical as each of these materials can contaminate the PET stream and reduce the quality of the final sorted product. After separation, the clear PET bottles are ground into flake, cleaned, and dried at temperatures between 140° C. and 180° C. The flake may be used directly (for example in strapping and fiber extrusion) or further processed into pellets for film, sheet or bottle applications. For some applications the pellets may be further crystallized and solid-state polymerized at temperatures between 200° C. and 220° C. prior to use. Because of the well-established nature of this process it is desirable for copolyester-based molded articles and containers to be compatible with the existing PET recycle stream.

The present disclosure addresses this long felt commercial need for durable molded articles produced from copolyester thermoplastic materials that are transparent, as well as clear, tough, and hot-fillable, and are also recyclable in a PET stream.

One embodiment of the present invention is a thermoformable article comprising a multilayer film or sheet comprising:

at least one layer (A1) which comprises a copolyester composition comprising a TMCD modified PET; at least one layer (B) which comprises a polyester composition comprising PET or a slightly modified PET; and optionally, at least one layer (A2) which comprises a copolyester composition comprising a TMCD modified PET; and wherein the article is clear, hot-fillable, and recyclable (RIC-1).

In one embodiment of the present disclosure, the Tg of the layer (A1) and layer (A2) copolyester compositions are about 100° C. or greater and the Tg of layer (B) polyester composition is from about 73° C. to about 83° C. as determined using a TA DSC 2920 from Thermal Analyst Instrument at a scan rate of 20° C./min.

In some embodiments, the TMCD raises the Tg of the copolyester compositions which enables use in hot-fill applications. In some embodiments, the level of TMCD provides the toughness and heat resistance that enables the temperature resistance required for hot-filling and drop test performance. In one embodiment, the level of TMCD in the copolyester compositions ranges 10-50 mol%.

One embodiment of the present disclosure is a thermoformable article comprising a multilayer film or sheet comprising: at least one layer (A1) which comprises a high Tg copolyester composition with a Tg greater than 100° C.; at least one layer (B) which comprises a lower Tg polyester composition with a Tg less than 100° C.; and optionally, at least one layer (A2) which comprises a high Tg copolyester composition with a Tg greater than 100° C.; and wherein the article is clear and hot-fillable.

One embodiment of the present disclosure is a thermoformable article comprising a multilayer film or sheet comprising: at least one layer (A1) which comprises a TMCD modified copolyester composition; at least one layer (B) which comprises a polyester composition comprising PET or a slightly modified PET; and optionally, at least one layer (A2) which comprises a TMCD modified copolyester composition; and wherein the article is clear and hot-fillable.

In one embodiment of the present disclosure, the copolyester composition comprising a TMCD modified PET comprises: (a) a dicarboxylic acid component comprising: (i) about 70 to about 100 mole% of terephthalic acid residues; (ii) about 0 to about 30 mole% of aromatic and/or aliphatic dicarboxylic acid residues having up to 20 carbon atoms; and (b) a diol component comprising: (i) about 0 to about 40 mole % 2,2-dimethylpropane-1,3-diol (neopentyl glycol or NPG) residues; (ii) about 0 to about 100 mole % 1,4-cyclohexanedimethanol (CHDM) residues; (iii) about 0.01% to about 50 mole % 2,2,4,4-tetramethyl-1,3-cyclobutanediol (TMCD) residues; (iv) about 0 to about 10 mole percent diethylene glycol (DEG) residues, whether or not formed in situ; wherein the remainder of the glycol component comprises: (v) residues of ethylene glycol, and (vi) optionally, about 0 to about 10 mole% of the residues of at least one other modifying glycol; wherein the total mole% of the dicarboxylic acid component is 100 mole%, and wherein the total mole% of the glycol component is 100 mole%.

In one embodiment, the copolyester composition comprising a TMCD modified PET comprises: (a) a dicarboxylic acid component comprising: (i)about 70 to about 100 mole% of terephthalic acid residues; (ii) about 0 to about 30 mole% of aromatic and/or aliphatic dicarboxylic acid residues having up to 20 carbon atoms; and (b) a diol component comprising: (i) about 0 to about 100 mole % ethylene glycol (EG) residues; (ii) about 0 to about 100 mole % 1,4-cyclohexanedimethanol (CHDM) residues; (iii) about 0.01 to about 50 mole % 2,2,4,4-tetramethyl-1,3-cyclobutanediol (TMCD) residues; (iv) about 0 to about 40 mole % 2,2-dimethylpropane-1,3-diol (neopentyl glycol or NPG) residues; (v) about 0 to about 10 mole percent diethylene glycol (DEG) residues, whether or not formed in situ; wherein the remainder of the glycol component comprises: (vi) optionally, about 0 to about 10 mole% of the residues of at least one other modifying glycol; wherein the total mole% of the dicarboxylic acid component is 100 mole%, and wherein the total mole% of the glycol component is 100 mole%.

In one embodiment, the copolyester composition comprising a TMCD modified PET comprises: (a) a dicarboxylic acid component comprising: (i) about 70 to about 100 mole% of terephthalic acid residues; (ii) about 0 to about 30 mole% of aromatic and/or aliphatic dicarboxylic acid residues having up to 20 carbon atoms; and (a) a diol component comprising: (i) about 0 to about 100 mole % ethylene glycol (EG) residues; (ii) about 0.01 to about 50 mole % 2,2,4,4-tetramethyl-1,3-cyclobutanediol (TMCD) residues; (iii) about 0 to about 10 mole percent diethylene glycol (DEG) residues, whether or not formed in situ; wherein the remainder of the glycol component comprises: (iv) optionally, about 0 to about 10 mole% of the residues of at least one other modifying glycol; wherein the total mole% of the dicarboxylic acid component is 100 mole%, and wherein the total mole% of the glycol component is 100 mole%.

In one embodiment, the copolyester composition comprising a TMCD modified PET comprises: (a) a dicarboxylic acid component comprising: (i) about 70 to about 100 mole% of terephthalic acid residues; (ii) about 0 to about 30 mole% of aromatic and/or aliphatic dicarboxylic acid residues having up to 20 carbon atoms; and (b) a diol component comprising: (i) about 0 to about 100 mole % ethylene glycol (EG) residues; (ii) about 0 to about 100 mole % 1,4-cyclohexanedimethanol (CHDM) residues; (iii) about 0.01 to about 50 mole % 2,2,4,4-tetramethyl-1,3-cyclobutanediol (TMCD) residues; (iv) about 0 to about 10 mole percent diethylene glycol (DEG) residues, whether or not formed in situ; wherein the remainder of the glycol component comprises: (v) optionally, about 0 to about 10 mole% of the residues of at least one other modifying glycol; wherein the total mole% of the dicarboxylic acid component is 100 mole%, and wherein the total mole% of the glycol component is 100 mole%.

In one embodiment, the copolyester composition comprising a TMCD modified PET comprises: (a) a dicarboxylic acid component comprising: (i) about 70 to about 100 mole% of terephthalic acid residues; (ii) about 0 to about 30 mole% of aromatic and/or aliphatic dicarboxylic acid residues having up to 20 carbon atoms; and (b) a diol component comprising: (i) about 0 to about 100 mole % ethylene glycol (EG) residues; (ii) about 0 to about 50 mole % 2,2,4,4-tetramethyl-1,3-cyclobutanediol (TMCD) residues; (iii) about 0 to about 10 mole percent diethylene glycol (DEG) residues, whether or not formed in situ; wherein the remainder of the glycol component comprises: (iv) optionally, about 0 to about 10 mole% of the residues of at least one other modifying glycol; wherein the total mole% of the dicarboxylic acid component is 100 mole%, and wherein the total mole% of the glycol component is 100 mole%.

In one embodiment, the polyester composition comprising PET or a slightly modified PET comprises: (a) a dicarboxylic acid component comprising: (i) about 90 to about 100 mole% of terephthalic acid residues; (ii) about 0 to about 10 mole% of aromatic and/or aliphatic dicarboxylic acid residues having up to 20 carbon atoms; and (b) a diol component comprising: (i) about 90 to about 100 mole % ethylene glycol (EG) residues (ii) about 0 to about 10 mole % 1,4-cyclohexanedimethanol (CHDM) residues; (ii) about 0 to about 10 mole % 2,2,4,4-tetramethyl-1,3-cyclobutanediol (TMCD) residues; (iii) about 0 to about 10 mole percent diethylene glycol (DEG) residues, whether or not formed in situ; wherein the remainder of the glycol component comprises: (iv) optionally, about 0 to about 10 mole% of the residues of at least one other modifying glycol; wherein the total mole% of the dicarboxylic acid component is 100 mole%, and wherein the total mole% of the glycol component is 100 mole%.

In one embodiment, the layer A1 is about 3% to 15% of the article, layer B is about 70% to about 94% of the article, and layer A2 is about 3% to about 15% of the article based on the total weight of the article; or wherein layer A1 is about 5% to 10% of the article, layer B is about 80% to about 90% of the article, and layer A2 is about 5% to about 10% of the article, based on the total weight of the article.

In one embodiment, the thermoformable articles of the present disclosure are tough and have good drop test values.

In one embodiment, a high temperature copolyester resin (or a copolyester resin with high temperature resistant) provides the thermal stability required to enable hot-fill applications. In some embodiments, heat deflection temperature (HDT) is an indicator if a copolyester composition will produce articles that will start to creep or distort at high temperatures. HDT is measured using ASTM D648.

In one embodiment, the copolyester composition in layer A1 or layer A2 has a low pressure HDT of at least about 85° C. or at least about 90° C., or wherein the copolyester composition in layer A1 or layer A2 has a high pressure HDT of at least 75° C. or 80° C.

In one embodiment, the layer A1 and layer A2 are up to 30% of the multilayer film or sheet or layer A1 and layer A2 from 6% to 30% of the multilayer film or sheet.

In one embodiment, the multilayer film or sheet of the present disclosure is clear and has a haze value of about 3% or less, or 2% or less, or 1% or less.

In one embodiment, the thermoformable articles of the present disclosure are hot-fillable at any temperature required for the intended application. In one embodiment, the thermoformable articles of the present disclosure are hot-fillable at temperatures of about 80° C. to 100° C. or temperatures of about 85° C. or less, or about 90° C. or less, or about 95° C. or less, or about 100° C. or less.

In one embodiment, the thermoformable articles of the present disclosure are recyclable in a PET RIC-1 stream.

In one embodiment, the thermoformable articles of the present disclosure can be recycled or reused. In some embodiments, the multilayer edge trim produced during the thermoforming process can be melt processed back into the B layer without creating haze in the B layer.

In one embodiment, the thermoformable articles of the present disclosure have a melt temperature of 225° C.-255° C. In one embodiment, the multilayer A/B/A film or sheet has a melt temperature of 225° C.-255° C. In some embodiments, the A/B/A structure when it is melted and mixed during the recycling process has a melt temperature of 225° C.-255° C.

In one embodiment, the multilayer film or sheet is produced by coextrusion, lamination, or a blown film process. In some embodiments, the multilayer film or sheet has good adhesion. In some embodiments, good adhesion means that the multilayer structure does not de-laminate during the application processes of thermoforming, hot filling and sealing or at application conditions.

In one embodiment of the present disclosure is a thermoformed article comprising at least one layer (A1) which comprises a copolyester composition comprising a TMCD modified PET; at least one layer (B) which comprises a polyester composition comprising PET or a slightly modified PET; and optionally, at least one layer (A2) which comprises a copolyester composition comprising a TMCD modified PET; wherein the article is clear, hot-fillable, and recyclable (RIC-1).

In one embodiment, the thermoformed or thermoformable article has a A/B or B/A bilayer structure.

In one embodiment, the thermoformed or thermoformable article has a A/B/A trilayer structure.

In one embodiment, the thermoformed or thermoformable article has a B/A/B trilayer structure.

In one embodiment, the thermoformed or thermoformable article has a five-layer A/B/A/B/A structure.

In one embodiment, the thermoformed or thermoformable article has any desired number of layers in any structural combination. For example, in one embodiment the thermoformed or thermoformable article has (A1)/(B) structure, (B)/(A1) structure , (A1)/(B)/(A1) structure, (A1)/(B)/(A2) structure (B)/(A1)/(B) structure, (A1)/(B)/(A1)/(B)/(A1) structure, (A1)/(B)/(A1)/(B)/(A2) structure or (A1)/(B)/(A2)/(B)/(A1) structure.

One embodiment of the present disclosure is a molded, thermoformed, or shaped article comprising the multilayer film or sheet of any of the preceding embodiments.

One embodiment of the present disclosure is Medical packaging, form-filled sealed packaging, reusable packaging, face shields, healthcare supplies, commercial foodservice products, residential foodservice products, blenders, consumer appliances, consumer electronics devices, automotive parts, cosmetics packaging, trays, containers, food pans, tumblers, cups, storage boxes, bottles, water bottles, washing machine parts, refrigerator parts, vacuum cleaner parts, or toys comprising the thermoformed or thermoformable film or sheet of any of the preceding embodiments.

One embodiment of the present disclosure is an article of manufacture comprising the thermoformed or thermoformable film or sheet of any of the preceding claims.

One embodiment of the present disclosure is a method of making the thermoformed film or sheet of any of the preceding embodiments comprising: 1) heating the multilayer film or sheet; 2) applying air pressure, vacuum and/or physical pressure to the heat softened film or sheet; 3) conforming the sheet by vacuum or pressure to a mold shape; and 4) removing the thermoformed part or article from the mold.

### DETAILED DESCRIPTION

The present disclosure may be understood more readily by reference to the following detailed description of certain embodiments of the disclosure. In accordance with the purpose(s) of this disclosure, certain embodiments of the disclosure are described in the Summary of the Invention and are further described herein below. Also, other embodiments of the disclosure are described herein.

The present disclosure pertains to certain multilayer film or sheet which can produce thermoformed articles having the following attributes, all of which are becoming increasingly critical to market needs: (1) the articles are hot-fillable; (2) the articles are clear (low haze); (3) the multilayer articles have a melting temperature (Tm) of 225-255° C., so they qualify as PET for recycling purposes and can be recycled at end of life with current, well established PET recycle streams; and (4) the multilayer articles may contain recycled or reused material.

In one aspect the multilayered articles of the present disclosure pertain to copolyester-based, environmentally friendly and sustainable articles for durable and consumer-oriented product applications that have two critical attributes. First, the articles of the present disclosure enable the ability to mold tough, hot-fillable, clear articles. Second, the articles of the present disclosure are compatible in PET recycle streams, i.e. they can be processed under the conditions used for homopolymer PET recycling.

In 2017, California Assembly Bill No. 906 - Beverage containers: polyethylene terephthalate was signed into law, and it defines “polyethylene terephthalate” (PET) for purposes of resin code labeling as a plastic that meets certain conditions, including limits with respect to the chemical composition of the polymer and a melting peak temperature within a specified range. AB-906 adds Section 18013 to California’s Public Resources Code, which reads, in part: “Polyethylene terephthalate (PET)” means a plastic derived from a reaction between terephthalic acid or dimethyl terephthalate and monoethylene glycol as to which both of the following conditions are satisfied:

a. The terephthalic acid or dimethyl terephthalate and monoethylene glycol reacted constitutes at least 90 percent of the mass of the monomer reacted to form the polymer.

b. The plastic exhibits a melting peak temperature that is between 225° C. and 255° C., as determined during the second thermal scan using procedure 10.1 as set forth in ASTM International (ASTM) D3418 with a heating rate of a sample at 10° C. per minute.”

As such, copolyesters, and blends of the aforementioned which meet both of the conditions outlined in AB-906, are acceptable for being called “PET”, and thus such materials are likely to be compatible in current PET recycle streams. The melting points of the multilayer articles in the present disclosure make them acceptable under this definition as PET, and thus, compatible in the current PET recycle streams.

Thus, in one aspect of the present disclosure, “compatible with PET recycle streams” is defined as exhibiting a melting temperature of 225° C.-255° C. on the first heat DSC scan of a molded part, while also containing 10 wt% or less of glycols and/or acids other than EG, TPA, or DMT. In the present disclosure, it has been found that multilayer articles of certain combinations of PET polyesters and TMCD modified copolyesters can produce thermoformed articles with (1) low haze (clear); (2) tough; (3) hot-fillable and (4) recyclability in a PET recycle stream.

In one embodiment of the present disclosure, the multilayer articles of the present disclosure have melting temperatures and weight percent comonomer content loading consistent with the definitions in the Assembly Bill, thus it is expected that the multilayer articles of the present disclosure can be processed in standard PET recycle processes.

These multilayer articles in the present disclosure are also recyclable, and they can be processed with PET recycle streams and end up as a component in the recyclable PET flake leaving the recycling process. The optimized PET polyester and copolyester multilayer articles of this disclosure have the melting point which enables the thermoformed articles to be recycled.

In one embodiment, the PET polyester compositions may have minor modifications such as with up to 5 mole% of isophthalic acid and/or up to 5 mole % of CHDM or other diols.

During the recycling process, drying of the PET flake is required to remove residual water that remains with the PET through the recycling process. Typically, PET is dried at temperatures above 200° C. At those temperatures, some copolyester resins will soften and become sticky, often creating clumps with PET flakes. These clumps must be removed before further processing. These clumps reduce the yield of PET flake from the process and create an additional handling step.

In some embodiments, the term polyester is intended to include copolyesters. In some embodiments, the term polyester is used to describe the PET and slightly modified PET used in the B layers of the present disclosure. In some embodiments, the term copolyester describes the modified, high-temperature resins that contain glycols such as CHDM and TMCD used in the A layers of the present disclosure.

The term “polyester”, as used herein, is intended to include “copolyesters” and is understood to mean a synthetic polymer prepared by the reaction of one or more difunctional carboxylic acids and/or multifunctional carboxylic acids with one or more difunctional hydroxyl compounds and/or multifunctional hydroxyl compounds, for example, branching agents. Typically, the difunctional carboxylic acid can be a dicarboxylic acid and the difunctional hydroxyl compound can be a dihydric alcohol, for example, glycols and diols. The term “glycol” as used herein includes, but is not limited to, diols, glycols, and/or multifunctional hydroxyl compounds, for example, branching agents. Alternatively, the difunctional carboxylic acid may be a hydroxy carboxylic acid, for example, p-hydroxybenzoic acid, and the difunctional hydroxyl compound may have an aromatic nucleus bearing 2 hydroxyl substituents, for example, hydroquinone. The term “residue”, as used herein, means any organic structure incorporated into a polymer through a polycondensation and/or an esterification reaction from the corresponding monomer. The term “repeating unit”, as used herein, means an organic structure having a dicarboxylic acid residue and a diol residue bonded through an ester group. Thus, for example, the dicarboxylic acid residues may be derived from a dicarboxylic acid monomer or its associated acid halides, esters, salts, anhydrides, and/or mixtures thereof. Furthermore, as used herein, the term “diacid” includes multifunctional acids, for example, branching agents. As used herein, therefore, the term “dicarboxylic acid” is intended to include dicarboxylic acids and any derivative of a dicarboxylic acid, including its associated acid halides, esters, half-esters, salts, half-salts, anhydrides, mixed anhydrides, and/or mixtures thereof, useful in a reaction process with a diol to make a polyester. As used herein, the term “terephthalic acid” is intended to include terephthalic acid itself and residues thereof as well as any derivative of terephthalic acid, including its associated acid halides, esters, half-esters, salts, half-salts, anhydrides, mixed anhydrides, and/or mixtures thereof or residues thereof useful in a reaction process with a diol to make a polyester.

The polyesters used in the present disclosure typically can be prepared from dicarboxylic acids and diols which react in substantially equal proportions and are incorporated into the polyester polymer as their corresponding residues. The polyesters of the present disclosure, therefore, can contain substantially equal molar proportions of acid residues (100 mole%) and diol (and/or multifunctional hydroxyl compound) residues (100 mole%) such that the total moles of repeating units is equal to 100 mole%. The mole percentages provided in the present disclosure, therefore, may be based on the total moles of acid residues, the total moles of diol residues, or the total moles of repeating units. For example, a polyester containing 10 mole% isophthalic acid, based on the total acid residues, means the polyester contains 10 mole% isophthalic acid residues out of a total of 100 mole% acid residues. Thus, there are 10 moles of isophthalic acid residues among every 100 moles of acid residues. In another example, a polyester containing 25 mole% 1,4-cyclohexanedimethanol, based on the total diol residues, means the polyester contains 25 mole% 1,4-cyclohexanedimethanol residues out of a total of 100 mole% diol residues. Thus, there are 25 moles of 1,4-cyclohexanedimethanol residues among every 100 moles of diol residues.

In certain embodiments, terephthalic acid or an ester thereof, for example, dimethyl terephthalate or a mixture of terephthalic acid residues and an ester thereof can make up a portion or all of the dicarboxylic acid component used to form the polyesters useful in the present disclosure. In certain embodiments, terephthalic acid residues can make up a portion or all of the dicarboxylic acid component used to form the polyesters useful in this disclosure. For the purposes of this disclosure, the terms “terephthalic acid” and “dimethyl terephthalate” are used interchangeably herein. In one embodiment, dimethyl terephthalate is part or all of the dicarboxylic acid component used to make the polyesters useful in the present disclosure. In embodiments, ranges of from 70 to 100 mole%; or 80 to 100 mole%; or 90 to 100 mole%; or 99 to 100 mole%; or 100 mole% terephthalic acid and/or dimethyl terephthalate and/or mixtures thereof may be used.

In addition to terephthalic acid, the dicarboxylic acid component of the polyesters useful in the present disclosure can comprise up to 30 mole%, up to 20 mole%, up to 10 mole%, up to 5 mole%, or up to 1 mole% of one or more modifying aromatic dicarboxylic acids. Yet another embodiment contains 0 mole% modifying aromatic dicarboxylic acids. Thus, if present, it is contemplated that the amount of one or more modifying aromatic dicarboxylic acids can range from any of these preceding endpoint values including, for example, 0.01 to 10 mole%, from 0.01 to 5 mole% and from 0.01 to 1 mole%. In one embodiment, modifying aromatic dicarboxylic acids that may be used in the present disclosure include but are not limited to those having up to 20 carbon atoms, and which can be linear, para-oriented, or symmetrical. Examples of modifying aromatic dicarboxylic acids which may be used in this disclosure include, but are not limited to, isophthalic acid, 4,4′-biphenyldicarboxylic acid, 1,4-, 1,5-, 2,6-, 2,7-naphthalenedicarboxylic acid, and trans-4,4′-stilbenedicarboxylic acid, and esters thereof. In one embodiment, the modifying aromatic dicarboxylic acid is isophthalic acid.

The carboxylic acid component of the polyesters useful in the present disclosure can be further modified with up to 10 mole%, such as up to 5 mole% or up to 1 mole% of one or more aliphatic dicarboxylic acids containing 2-16 carbon atoms, for example, cyclohexanedicarboxylic, malonic, succinic, glutaric, adipic, pimelic, suberic, azelaic and/or dodecanedioic dicarboxylic acids. Certain embodiments can also comprise 0.01 to 10 mole%, such as 0.1 to 10 mole%, 1 or 10 mole%, 5 to 10 mole% of one or more modifying aliphatic dicarboxylic acids. Yet another embodiment contains 0 mole% modifying aliphatic dicarboxylic acids. The total mole% of the dicarboxylic acid component is 100 mole%. In one embodiment, adipic acid and/or glutaric acid are provided in the modifying aliphatic dicarboxylic acid component of the polyesters and are useful in the present disclosure.

Esters of terephthalic acid and the other modifying dicarboxylic acids or their corresponding esters and/or salts may be used instead of the dicarboxylic acids. Suitable examples of dicarboxylic acid esters include, but are not limited to, the dimethyl, diethyl, dipropyl, diisopropyl, dibutyl, and diphenyl esters. In one embodiment, the esters are chosen from at least one of the following: methyl, ethyl, propyl, isopropyl, and phenyl esters.

In one embodiment, the diol component of the copolyester compositions useful in the present disclosure can comprise 1,4-cyclohexanedimethanol. In another embodiment, the diol component of the copolyester compositions useful in the present disclosure comprise 1,4-cyclohexanedimethanol and 1,3-cyclohexanedimethanol. The molar ratio of cis/trans 1 ,4-cyclohexandimethanol can vary within the range of 50/50 to 0/100, for example, between 40/60 to 20/80.

In one embodiment, the glycol component of the copolyesters useful in the present disclosure can comprise 2,2,4,4-tetramethyl-1,3-cyclobutanediol. In another embodiment, the molar ratio of cis/trans 2,2,4,4-tetramethyl-1,3-cyclobutanediol can vary from the pure form of each and mixtures thereof. In certain embodiments, the molar percentages for cis and/or trans 2,2,4,4,-tetramethyl-1,3-cyclobutanediol are greater than 50 mole % cis and less than 50 mole % trans; or greater than 55 mole % cis and less than 45 mole % trans; or 50 to 70 mole % cis and 50 to 30 mole % trans; or 60 to 70 mole % cis and 30 to 40 mole % trans; or greater than 70 mole % cis and less than 30 mole % trans; wherein the total mole percentages for cis- and trans-2,2,4,4-tetramethyl-1,3-cyclobutanediol is equal to 100 mole %. In an additional embodiment, the molar ratio of cis/trans 2,2,4,4-tetramethyl-1,3-cyclobutanediol can vary within the range of 50/50 to 0/100, for example, between 40/60 to 20/80.

In one embodiment, the total comonomer content from glycols and acids other than ethylene glycol (EG), terephthalic acid (TPA), or dimethyl terephthalate (DMT) of the copolyester compositions useful in the present disclosure is from 1 to 10 wt%, or from 5 to 10 wt%, or from 2 to 10 wt%, or from 3 to 10 wt%, or from 4 to 10 wt%, or from 6 to 10 wt%, or from 7 to 10 wt%, or from 8 to 10 wt%, or from 9 to 10 wt%.

In one embodiment, the glycol component of the copolyester compositions useful in this disclosure can contain 0 to 50 mole% of neopentyl glycol based on the total mole% of the glycol component being 100 mole%. In one embodiment, the glycol component of the copolyester compositions useful in this disclosure can contain 0 to 25 mole% of neopentyl glycol based on the total mole% of the glycol component being 100 mole%. In one embodiment, the glycol component of the copolyester compositions useful in this disclosure can contain 0 to 50 mole% of neopentyl glycol based on the total mole% of the glycol component being 100 mole%. In one embodiment, the glycol component of the copolyester compositions useful in this disclosure can contain 5 to 50 mole% of neopentyl glycol based on the total mole% of the glycol component being 100 mole%. In one embodiment, the glycol component of the copolyesters compositions useful in this disclosure can contain 10 to 30 mole% of neopentyl glycol based on the total mole% of the glycol component being 100 mole%. In one embodiment, the glycol component of the copolyester compositions useful in this disclosure can contain 10 to 15 mole% of neopentyl glycol based on the total mole% of the glycol component being 100 mole%. In one embodiment, the glycol component of the copolyester compositions useful in this disclosure can contain 15 to 45 mole% of neopentyl glycol based on the total mole% of the glycol component being 100 mole%.

In one embodiment, the glycol component of the copolyester compositions useful in this disclosure can contain from 0 to 50 mole%, or from 0 to 40 mole%, or from 0 to 30 mole%, or from 0 to 20 mole%, or from 0 to 10 mole%, or from 0.01 to 50 mole%, or from 0.01 to 40 mole%, or from 0.01 to 30 mole%, or from 0.01 to 20 mole%, or from 0.01 to 15 mole%, or from 0.01 to 14 mole%, or from 0.01 to 13 mole%, or from 0.01 to 12 mole%, or from 0.01 to 11 mole%, or 0.01 to 10 mole%, or from 0.01 to 9 mole%, or from 0.01 to 8 mole%, or from 0.01 to 7 mole%, or from 0.01 to 6 mole%, or from 0.01 to 5 mole%, or from 0.1 to 50 mole%, or from 0.1 to 40 mole%, or from 0.1 to 30 mole%, or from 0.1 to 20 mole%, or from 0.1 to 10 mole%, or from 5 to 50 mole%, 10 to 50 mole%, or from 20 to 50 mole%, or from 30 to 50 mole%, or from 40 to 50 mole%, or from 20 to 40 mole%, or 30 to 40 mole%, or from 10 to 40 mole%, 10 to 30 mole%, or from 10 to 20 mole%, or from 20 to 30 mole%, or from 2 to 50 mole%, or from 2 to 40 mole%, or 2 to 30 mole%, or from 2 to 20 mole%, 3 to 15 mole%, or from 3 to 14 mole%, or from 3 to 13 mole%, or from 3 to 12 mole%, or from 3 to 11 mole%, or 3 to 10 mole%, or from 3 to 9 mole%, or from 3 to 8 mole%, or from 3 to 7 mole%, or from 2 to 10 mole%, or from 2 to 9 mole%, or from 2 to 8 mole%, or from 2 to 7 mole%, or from 2 to 5 mole%, or from 1 to 7 mole%, or from 1 to 5 mole%, or from 1 to 3 mole%, of neopentyl glycol residues, based on the total mole% of the glycol component being 100 mole%.

In one embodiment, the glycol component of the copolyester compositions useful in this disclosure can contain from 0 to 100 mole% or from 0 to 50 mole% of 1,4-cyclohexanedimethanol based on the total mole% of the glycol component being 100 mole%. In one embodiment, the glycol component of the copolyester compositions useful in this disclosure can contain 0.01 to less than 50 mole% of 1,4-cyclohexanedimethanol based on the total mole% of the glycol component being 100 mole%. In one embodiment, the glycol component of the copolyester compositions useful in this disclosure can contain 0 to 15 mole% of 1,4-cyclohexanedimethanol based on the total mole% of the glycol component being 100 mole%. In one embodiment, the glycol component of the copolyester compositions useful in this disclosure can contain 0.01 to less than 15 mole% of 1,4-cyclohexanedimethanol based on the total mole% of the glycol component being 100 mole%. In one embodiment, the glycol component of the copolyester compositions useful in this disclosure can contain 0.01 to 5 mole% of 1 ,4-cyclohexanedimethanol based on the total mole% of the glycol component being 100 mole%. In one embodiment, the glycol component of the copolyester compositions useful in this disclosure can contain 0 to less than 5 mole% of 1,4-cyclohexanedimethanol based on the total mole% of the glycol component being 100 mole%.

In one embodiment, the glycol component of the copolyester compositions useful in this disclosure can contain from 0 to 100 mole%, or from 0 to 50 mole%, or from 0 to 40 mole%, or from 0 to 30 mole%, or from 0 to 20 mole%, or from 0 to 10 mole%, or from 0.01 to 50 mole%, or from 0.01 to 40 mole%, or from 0.01 to 30 mole%, or from 0.01 to 20 mole%, or from 0.01 to 15 mole%, or from 0.01 to 14 mole%, or from 0.01 to 13 mole%, or from 0.01 to 12 mole%, or from 0.01 to 11 mole%, or 0.01 to 10 mole%, or from 0.01 to 9 mole%, or from 0.01 to 8 mole%, or from 0.01 to 7 mole%, or from 0.01 to 6 mole%, or from 0.01 to 5 mole%, or from 0.1 to 50 mole%, or from 0.1 to 40 mole%, or from 0.1 to 30 mole%, or from 0.1 to 20 mole%, or from 0.1 to 10 mole%, or from 5 to 50 mole%, 10 to 50 mole%, or from 20 to 50 mole%, or from 30 to 50 mole%, or from 40 to 50 mole%, or from 20 to 40 mole%, or 30 to 40 mole%, or from 10 to 40 mole%, 10 to 30 mole%, or from 10 to 20 mole%, or from 20 to 30 mole%, or from 2 to 50 mole%, or from 2 to 40 mole%, or 2 to 30 mole%, or from 2 to 20 mole%, 3 to 15 mole%, or from 3 to 14 mole%, or from 3 to 13 mole%, or from 3 to 12 mole%, or from 3 to 11 mole%, or 3 to 10 mole%, or from 3 to 9 mole%, or from 3 to 8 mole%, or from 3 to 7 mole%, or from 2 to 10 mole%, or from 2 to 9 mole%, or from 2 to 8 mole%, or from 2 to 7 mole%, or from 2 to 5 mole%, or from 1 to 7 mole%, or from 1 to 5 mole%, or from 1 to 3 mole%, 1,4-cyclohexanedimethanol residues, based on the total mole% of the glycol component being 100 mole%.

In one embodiment, the glycol component of the copolyester compositions useful in this disclosure can contain from 0 to 50 mole%, or from 0 to 45 mole%, or from 0 to 40 mole%, or from 0 to 35 mole%, or from 0 to 30 mole%, or from 0 to 25 mole%, or from 0 to 20 mole%, or from 0 to 10 mole%, or from 0.01 to 50 mole%, or from 0.01 to 45 mole%, or from 0.01 to 40 mole%, or from 0.01 to 35 mole%, or from 0.01 to 30 mole%, or from 0.01 to 25 mole%, or from 0.01 to 20 mole%, or from 0.01 to 15 mole%, or from 0.01 to 14 mole%, or from 0.01 to 13 mole%, or from 0.01 to 12 mole%, or from 0.01 to 11 mole%, or 0.01 to 10 mole%, or from 0.01 to 9 mole%, or from 0.01 to 8 mole%, or from 0.01 to 7 mole%, or from 0.01 to 6 mole%, or from 0.01 to 5 mole%, or from 0.1 to 35 mole%, or from 0.1 to 30 mole%, or from 0.1 to 25 mole%, or from 0.1 to 20 mole%, or from 0.1 to 10 mole%, or from 10 to 50 mole%, or from 10 to 45 mole%, or from 10 to 40 mole%, or from 20 to 50 mole%, or from 20 to 45 mole%, or from 20 to 40 mole%, or from 25 to 50 mole%, or from 25 to 45 mole%, or from 25 to 40 mole%, or from 5 to 35 mole%, 10 to 35 mole%, or from 20 to 35 mole%, or from 25 to 35 mole%, 10 to 30 mole%, or from 10 to 20 mole%, or from 20 to 30 mole%, or from 2 to 35 mole%, or from 2 to 25 mole%, or 2 to 30 mole%, or from 2 to 20 mole%, 3 to 15 mole%, or from 3 to 14 mole%, or from 3 to 13 mole%, or from 3 to 12 mole%, or from 3 to 11 mole%, or 3 to 10 mole%, or from 3 to 9 mole%, or from 3 to 8 mole%, or from 3 to 7 mole%, or from 2 to 10 mole%, or from 2 to 9 mole%, or from 2 to 8 mole%, or from 2 to 7 mole%, or from 2 to 5 mole%, or from 1 to 7 mole%, or from 1 to 5 mole%, or from 1 to 3 mole%, of 2,2,4,4-tetramethyl-1 ,3-cyclobutanediol residues, based on the total mole% of the glycol component being 100 mole%.

In one embodiment, the glycol component of the copolyester compositions useful in this disclosure can contain 0 to 45 mole% of 2,2,4,4-tetramethyl-1,3-cyclobutanediol based on the total mole% of the glycol component being 100 mole%. In one embodiment, the glycol component of the copolyester compositions useful in this disclosure can contain 0.01 to less than 45 mole% of 2,2,4,4-tetramethyl-1,3-cyclobutanediol based on the total mole% of the glycol component being 100 mole%. In one embodiment, the glycol component of the copolyester compositions useful in this disclosure can contain 0 to 40 mole% of 2,2,4,4-tetramethyl-1,3-cyclobutanediol based on the total mole% of the glycol component being 100 mole%. In one embodiment, the glycol component of the copolyester compositions useful in this disclosure can contain 0.01 to less than 40 mole% of 2,2,4,4-tetramethyl-1,3-cyclobutanediol based on the total mole% of the glycol component being 100 mole%. In one embodiment, the glycol component of the copolyester compositions useful in this disclosure can contain 0 to 35 mole% of 2,2,4,4-tetramethyl-1,3-cyclobutanediol based on the total mole% of the glycol component being 100 mole%. In one embodiment, the glycol component of the copolyester compositions useful in this disclosure can contain 0.01 to less than 35 mole% of 2,2,4,4-tetramethyl-1,3-cyclobutanediol based on the total mole% of the glycol component being 100 mole%. In one embodiment, the glycol component of the copolyester compositions useful in this disclosure can contain 0 to 30 mole% of 2,2,4,4-tetramethyl-1,3-cyclobutanediol based on the total mole% of the glycol component being 100 mole%. In one embodiment, the glycol component of the copolyester compositions useful in this disclosure can contain 0.01 to less than 30 mole% of 2,2,4,4-tetramethyl-1,3-cyclobutanediol based on the total mole% of the glycol component being 100 mole%. In one embodiment, the glycol component of the copolyester compositions useful in this disclosure can contain 0.01 to 25 mole% of 2,2,4,4-tetramethyl-1,3-cyclobutanediol based on the total mole% of the glycol component being 100 mole%. In one embodiment, the glycol component of the copolyester compositions useful in this disclosure can contain 0 to less than 25 mole% of 2,2,4,4-tetramethyl-l,3-cyclobutanediol based on the total mole% of the glycol component being 100 mole%. In one embodiment, the glycol component of the copolyester compositions useful in this disclosure can contain 10 to 50 mole% of 2,2,4,4-tetramethyl-1,3-cyclobutanediol based on the total mole% of the glycol component being 100 mole%. In one embodiment, the glycol component of the copolyester compositions useful in this disclosure can contain 10 to 45 mole% of 2,2,4,4-tetramethyl-1,3-cyclobutanediol based on the total mole% of the glycol component being 100 mole%. In one embodiment, the glycol component of the copolyester compositions useful in this disclosure can contain 10 to 40 mole% of 2,2,4,4-tetramethyl-1,3-cyclobutanediol based on the total mole% of the glycol component being 100 mole%. In one embodiment, the glycol component of the copolyester compositions useful in this disclosure can contain 20 to 50 mole% of 2,2,4,4-tetramethyl-1,3-cyclobutanediol based on the total mole% of the glycol component being 100 mole%. In one embodiment, the glycol component of the copolyester compositions useful in this disclosure can contain 20 to 45 mole% of 2,2,4,4-tetramethyl-1,3-cyclobutanediol based on the total mole% of the glycol component being 100 mole%. In one embodiment, the glycol component of the copolyester compositions useful in this disclosure can contain 20 to 40 mole% of 2,2,4,4-tetramethyl-1,3-cyclobutanediol based on the total mole% of the glycol component being 100 mole%.

It should be understood that some other glycol residues may be formed in situ during processing. For example, in one embodiment, the total amount of diethylene glycol residues can be present in the copolyesters useful in the present disclosure, whether or not formed in situ during processing or intentionally added, or both, in any amount, for example, from 1 to 15 mole%, or from 1 to 10 mole%, or from 1 to 8 mole%, or from 1 to 7 mole%, or from 1 to 6 mole%, or from 1 to 5 mole%, or from 1 to 2 mole%, or from 1 to 12 mole%, or from 2 to 12 mole%, or from 2 to 11 mole%, or 2 to 10 mole%, or from 2 to 9 mole%, or from 3 to 12 mole%, or from 3 to 11 mole%, or 3 to 10 mole%, or from 3 to 9 mole%, or from 4 to 12 mole%, or from 4 to 11 mole%, or 4 to 10 mole%, or from 4 to 9 mole%, or, from 5 to 12 mole%, or from 5 to 11 mole%, or 5 to 10 mole%, or from 5 to 9 mole%, of diethylene glycol residues, based on the total mole% of the glycol component being 100 mole%.

In one embodiment, the total amount of diethylene glycol (DEG) residues present in the copolyesters useful in the present disclosure, whether or not formed in situ during processing or intentionally added or both, can be from 5 mole% or less, or 4 mole% or less, or from 3.5 mole% or less, or from 3.0 mole% or less, or from 2.5 mole% or less, or from 2.0 mole% or less, or from 1.5 mole% or less, or from 1.0 mole% or less, or from 1 to 4 mole%, or from 1 to 3 mole%, or from 1 to 2 mole% of diethylene glycol residues, or from 2 to 8 mole%, or from 2 to 7 mole%, or from 2 to 6 mole%, or from 2 to 5 mole%, or from 3 to 8 mole%, or from 3 to 7 mole%, or from 3 to 6 mole%, or from 3 to 5 mole%, or in some embodiments there is no intentionally added diethylene glycol residues, based on the total mole% of the glycol component being 100 mole%. In certain embodiments, the copolyester contains no added modifying glycols. In certain embodiments, the diethylene glycol residues in copolyesters can be from 5 mole% or less. It should be noted that any low levels of DEG formed in situ are not included in the total comonomer content from glycols and acids other than EG, TPA or DMT.

For all embodiments, the remainder of the glycol component can comprise ethylene glycol residues in any amount based on the total mole% of the glycol component being 100 mole%. In one embodiment, the copolyesters useful in the present disclosure can contain 50 mole% or greater, or 55 mole% or greater, or 60 mole% or greater, or 65 mole% or greater, or 70 mole% or greater, or 75 mole% or greater, or 80 mole% or greater, or 85 mole% or greater, or 90 mole% or greater, or 95 mole% or greater, or 98 mole% or greater or from 50 to 90 mole%, or from 55 to 90 mole%, or from 50 to 80 mole%, or from 55 to 80 mole%, or from 60 to 80 mole%, or from 50 to 75 mole%, or from 55 to 75 mole%, or from 60 to 75 mole%, or from 65 to 75 mole% of ethylene glycol residues, based on the total mole% of the glycol component being 100 mole%.

In one embodiment, the glycol component of the copolyester compositions useful in the present disclosure can contain up to 10 mole%, or up to 9 mole%, or up to 8 mole%, or up to 7 mole%, or up to 6 mole%, or up to 5 mole %, or up to 4 mole %, or up to 3 mole %, or up to 2 mole %, or up to 1 mole %, or less of one or more other modifying glycols (other modifying glycols are defined as glycols which are not ethylene glycol, diethylene glycol, neopentyl glycol, 1,4-cyclohexanedimethanol, or 2,2,4,4-tetramethyl-1,3-cyclobutanediol). In certain embodiments, the copolyesters useful in this disclosure can contain 35 mole% or less of one or more other modifying glycols; 30 mole% or less of one or more other modifying glycols; 25 mole% or less of one or more other modifying glycols; 20 mole% or less of one or more other modifying glycols; 15 mole% or less of one or more other modifying glycols; 10 mole% or less of one or more other modifying glycols. In certain embodiments, the copolyesters useful in this disclosure can contain 5 mole% or less of one or more other modifying glycols. In certain embodiments, the copolyesters useful in this disclosure can contain 3 mole% or less of one or more other modifying glycols. In another embodiment, the copolyesters useful in this disclosure can contain 0 mole % of other modifying glycols. It is contemplated, however, that some other glycol residuals may form in situ so that residual amounts formed in situ are also an embodiment of this disclosure.

In embodiments, the other modifying glycols for use in the copolyesters, if used, as defined herein contain 2 to 16 carbon atoms. Examples of other modifying glycols include, but are not limited to, 1,2-propanediol, 1,3-propanediol, isosorbide, 1,4-butanediol, 1,5-pentanediol, 1,6-hexanediol, p-xylene glycol, and mixtures thereof. In one embodiment, isosorbide is an other modifying glycol. In one embodiment, polytetramethylene glycol is an other modifying glycol. In another embodiment, the other modifying glycols include, but are not limited to, at least one of 1,3-propanediol and 1,4-butanediol. In one embodiment, 1,3-propanediol and/or 1,4-butanediol can be excluded. If 1,4- or 1,3-butanediol are used, greater than 4 mole% or greater than 5 mole % can be provided in one embodiment. In one embodiment, at least one other modifying glycol is 1,4-butanediol which present in the amount of 5 to 35 mole%.

In some embodiments, the polyester and copolyester compositions according to the present disclosure can comprise from 0 to 10 mole%, for example, from 0.01 to 5 mole%, from 0.01 to 1 mole%, from 0.05 to 5 mole%, from 0.05 to 1 mole%, or from 0.1 to 0.7 mole%, based the total mole percentages of either the diol or diacid residues; respectively, of one or more residues of a branching monomer, also referred to herein as a branching agent, having 3 or more carboxyl substituents, hydroxyl substituents, or a combination thereof. In certain embodiments, the branching monomer or agent may be added prior to and/or during and/or after the polymerization of the polyester or copolyester. In some embodiments, the polyester(s) and copolyesters useful in the present disclosure can thus be linear or branched.

Examples of branching monomers include, but are not limited to, multifunctional acids or multifunctional alcohols such as trimellitic acid, trimellitic anhydride, pyromellitic dianhydride, trimethylolpropane, glycerol, pentaerythritol, citric acid, tartaric acid, 3-hydroxyglutaric acid and the like. In one embodiment, the branching monomer residues can comprise 0.01 to 0.7 mole% of one or more residues chosen from at least one of the following: trimellitic anhydride, pyromellitic dianhydride, glycerol, sorbitol, 1,2,6-hexanetriol, pentaerythritol, trimethylolethane, and/or trimesic acid. The branching monomer may be added to the polyester reaction mixture or blended with the polyester in the form of a concentrate as described, for example, in U.S. Pat. Nos. 5,654,347 and 5,696,176, whose disclosure regarding branching monomers is incorporated herein by reference.

The polyesters and copolyesters useful in the present disclosure can comprise at least one chain extender. Suitable chain extenders include, but are not limited to, multifunctional (including, but not limited to, bifunctional) isocyanates, multifunctional epoxides, including, for example, epoxylated novolacs, and phenoxy resins. In certain embodiments, chain extenders may be added at the end of the polymerization process or after the polymerization process. If added after the polymerization process, chain extenders can be incorporated by compounding or by addition during conversion processes such as injection molding or extrusion.

The amount of chain extender used can vary depending on the specific monomer composition used and the physical properties desired but is generally about 0.1 percent by weight to about 10 percent by weight, such as about 0.1 to about 5 percent by weight, based on the total weight of the polyester.

It is contemplated that polyester and copolyester compositions useful in the present disclosure can possess at least one of the inherent viscosity ranges described herein and at least one of the monomer ranges for the polyester compositions described herein, unless otherwise stated. It is also contemplated that polyester compositions useful in the present disclosure can possess at least one of the Tg ranges described herein and at least one of the monomer ranges for the polyester compositions described herein, unless otherwise stated. It is also contemplated that polyester compositions useful in the present disclosure can possess at least one of the inherent viscosity ranges described herein, at least one of the Tg ranges described herein, and at least one of the monomer ranges for the polyester or copolyester compositions described herein, unless otherwise stated.

For embodiments of this disclosure, the polyester and copolyester compositions useful in this disclosure can exhibit at least one of the following inherent viscosities as determined in 60/40 (wt/wt) phenol/ tetrachloroethane at a concentration of 0.25 g/50 ml at 25ºC: 0.50 to 1.2 dL/g; 0.50 to 1.0 dL/g; 0.50 to 0.90 dL/g; 0.50 to 0.80 dL/g; 0.55 to 0.80 dL/g; 0.60 to 0.80 dL/g; 0.65 to 0.80 dL/g; 0.70 to 0.80 dL/g; 0.50 to 0.75 dL/g; 0.55 to 0.75 dL/g; or 0.60 to 0.75 dL/g.

The glass transition temperature (Tg) of the polyester and copolyester compositions is determined using a TA DSC 2920 from Thermal Analyst Instrument at a scan rate of 20ºC/min. The value of the glass transition temperature is determined during the second heat.

In certain embodiments, the film or sheet of the A layer this disclosure comprise copolyesters compositions wherein the polyester has a Tg of at least 90° C. or of at least 100° C.; 90 to 115° C.; or 100 to 120° C.; or 90 to 100° C. In certain embodiments, these Tg ranges can be met with or without at least one plasticizer being added during polymerization.

In certain embodiments, the film or sheet of the B layer of this disclosure comprise polyester compositions wherein the polyester has a Tg of 65 to 85° C.; 73 to 83° C.; or 70 to 80° C.; or 75 to 85° C. In certain embodiments, these Tg ranges can be met with or without at least one plasticizer being added during polymerization.

In embodiments of the present disclosure, the films and/or sheet comprising the copolyester compositions useful in this disclosure can have a unique combination of all of the following properties: certain toughness, certain inherent viscosities, certain glass transition temperatures (Tg), certain heat deflection temperatures (HDT), certain melting points, certain melt viscosities and good color.

In one embodiment, certain polyester and copolyester compositions useful in this disclosure can be visually clear. The term “visually clear” is defined herein as an appreciable absence of cloudiness, haziness, and/or muddiness, when inspected visually. In one embodiment, certain copolyester compositions useful in this disclosure have good color or low haze values.

The polyester and copolyester compositions useful in this disclosure can be made by processes known from the literature, for example, by processes in homogenous solution, by transesterification processes in the melt, and by two phase interfacial processes. Suitable methods include, but are not limited to, the steps of reacting one or more dicarboxylic acids with one or more diols at a temperature of 100° C. to 315° C. at a pressure of 0.1 to 760 mm Hg for a time sufficient to form a polyester. See U.S. Pat. No. 3,772,405 for methods of producing polyesters, the disclosure regarding such methods is hereby incorporated herein by reference.

The polyesters and copolyesters in general may be prepared by condensing the dicarboxylic acid or dicarboxylic acid ester with the diol in the presence of a catalyst at elevated temperatures increased gradually during the course of the condensation up to a temperature of about 225° C. to 310° C., in an inert atmosphere, and conducting the condensation at low pressure during the latter part of the condensation, as described in further detail in U.S. Pat. No. 2,720,507 incorporated herein by reference herein.

In some embodiments, during the process for making certain polyester and copolyester compositions useful in the present disclosure, certain agents which colorize the polymer can be added to the melt including toners or dyes. In one embodiment, a bluing toner is added to the melt in order to reduce the b* of the resulting polyester polymer melt phase product. Such bluing agents include blue inorganic and organic toner(s) and/or dyes. In addition, red toner(s) and/or dyes can also be used to adjust the a* color. Organic toner(s), e.g., blue and red organic toner(s), such as those toner(s) described in U.S. Pat. Nos. 5,372,864 and 5,384,377, which are incorporated by reference in their entirety, can be used. The organic toner(s) can be fed as a premix composition. The premix composition may be a neat blend of the red and blue compounds or the composition may be pre-dissolved or slurried in one of the polyester’s raw materials, e.g., ethylene glycol.

The total amount of toner components added can depend on the amount of inherent yellow color in the base polyester or copolyester and the efficacy of the toner. In one embodiment, a concentration of up to about 15 ppm of combined organic toner components and a minimum concentration of about 0.5 ppm can be used. In one embodiment, the total amount of bluing additive can range from 0.5 to 10 ppm. In an embodiment, the toner(s) can be added to the esterification zone or to the polycondensation zone. Preferably, the toner(s) are added to the esterification zone or to the early stages of the polycondensation zone, such as to a prepolymerization reactor.

It is contemplated that polyester and copolyester compositions useful in the present disclosure can possess at least one of the inherent viscosity ranges described herein and at least one of the monomer ranges for the polyester or copolyester compositions described herein, unless otherwise stated. It is also contemplated that the polyester and copolyester compositions useful in the present disclosure can possess at least one of the Tg ranges described herein and at least one of the monomer ranges for the polyester and copolyester compositions described herein, unless otherwise stated. It is also contemplated that the polyester and copolyester compositions useful in the present disclosure can possess at least one of the inherent viscosity ranges described herein, at least one of the Tg ranges described herein, and at least one of the monomer ranges for the polyester and copolyester compositions described herein, unless otherwise stated.

For embodiments of this disclosure, the polyester and copolyester compositions useful in this disclosure can exhibit at least one of the following inherent viscosities as determined in 60/40 (wt/wt) phenol/ tetrachloroethane at a concentration of 0.25 g/50 ml at 25ºC: 0.50 to 1.2 dL/g; 0.50 to 1.0 dL/g; 0.50 to 0.90 dL/g; 0.50 to 0.80 dL/g; 0.55 to 1.2 dL/g; 0.55 to 1.0 dL/g; 0.55 to 0.90 dL/g; 0.55 to 0.80 dL/g; 0.58 to 1.2 dL/g; 0.58 to 1.0 dL/g; 0.58 to 0.90 dL/g; 0.58 to 0.80 dL/g; 0.60 to 0.90 dL/g; 0.60 to 0.80 dL/g; 0.65 to 0.90 dL/g; 0.60 to 0.80 dL/g 0.70 to 0.80 dL/g; 0.50 to 0.75 dL/g; 0.55 to 0.75 dL/g; 0.58 to 0.75 dL/g; 0.60 to 0.75 dL/g; 0.60 to 0.70 dL/g; 0.58 to 0.70 dL/g; or 0.55 to 0.70 dL/g.

In one embodiment, the compositions of the present disclosure are useful as plastics, films, fibers, and sheet. The compositions of this disclosure are useful as thermoformed articles and parts, extrusion blow molded or shaped articles, molded or shaped parts or as solid plastic objects. In one embodiment, the compositions of this disclosure are useful as thermoformed articles and parts, extrusion blow molded parts or molded articles. The compositions are suitable for use in any applications where clear, tough or rigid plastics are required. Examples of such parts and articles include containers, jars, cosmetics packaging, lids, decorative lids, personal care product packaging, ink pen barrels, disposable syringes, bottles, bottle caps, automotive interior parts, automotive trim, toys, toy parts, thermally conductive plastics, medical devices, dental appliances, food containers, shipping containers, packaging, furniture components, multiwall film, multilayer film, insulated parts, insulated articles, insulated containers, storage boxes, food processors, blender and mixer bowls, water bottles, washing machine parts, refrigerator parts, vacuum cleaner parts, thermally conductive plastics, healthcare supplies, commercial foodservice products, boxes medical packaging, and the like.

This disclosure further relates to articles of manufacture comprising the film(s) and/or sheet(s) containing the polyester and copolyester compositions described herein. In embodiments, the films and/or sheets of the present disclosure can be of any thickness as required for the intended application.

This disclosure further relates to the film(s) and/or sheet(s) described herein. The methods of forming the polyester and copolyester compositions into film(s) and/or sheet(s) includes any methods known in the art. Examples of film(s) and/or sheet(s) of the disclosure including but not limited to extruded film(s) and/or sheet(s), calendered film(s) and/or sheet(s), compression molded film(s) and/or sheet(s), Methods of making film and/or sheet include but are not limited to extrusion, calendering, and compression molding.

This disclosure further relates to the molded or shaped articles described herein. The methods of forming the polyester and copolyester compositions into molded or shaped articles includes any known methods in the art. Examples of molded or shaped articles of this disclosure including but not limited to thermoformed or thermoformable articles, extrusion molded articles, and extrusion blow molded articles. Methods of making molded articles include but are not limited to thermoforming, extrusion, and extrusion blow molding. The processes of this disclosure can include any thermoforming processes known in the art. The processes of this disclosure can include any blow molding processes known in the art including, but not limited to, extrusion blow molding, and extrusion stretch blow molding.

This disclosure includes any extrusion blow molding manufacturing process known in the art. Although not limited thereto, a typical description of extrusion blow molding manufacturing process involves: 1) melting the composition in an extruder; 2) extruding the molten composition through a die to form a tube of molten polymer (i.e. a parison); 3) clamping a mold having the desired finished shape around the parison; 4) blowing air into the parison, causing the extrudate to stretch and expand to fill the mold; 5) cooling the molded article; 6) ejecting the article of the mold; and 7) removing excess plastic (commonly referred to as flash) from the article.

In one embodiment, the molded articles and parts of the present disclosure can be of any thickness required for the intended end use application. In one embodiment, the thickness of the molded articles and parts of the present disclosure are greater than about 3mil. In one embodiment, the thickness of the molded articles and parts of the present disclosure are greater than about 4mil. In one embodiment, the thickness of the molded articles and parts of the present disclosure are greater than about 5mil. In one embodiment, the thickness of the molded articles and parts of the present disclosure are greater than about 1 mil. In one embodiment, the thickness of the molded articles and parts is from about 3mil to about 25mil. In one embodiment, the thickness of the molded articles and parts is from about 5mil to about 20mil.

In embodiments, the polyester or copolyester compositions can also contain from 0.01 to 25% by weight of the overall composition common additives such as colorants, toner(s), dyes, mold release agents, flame retardants, plasticizers, glass bubbles, nucleating agents, stabilizers, including but not limited to, UV stabilizers, thermal stabilizers, and/or reaction products thereof, fillers, and impact modifiers. Examples of commercially available impact modifiers include, but are not limited to, ethylene/propylene terpolymers, functionalized polyolefins such as those containing methyl acrylate and/or glycidyl methacrylate, styrene-based block copolymeric impact modifiers, and various acrylic core/shell type impact modifiers. Residues of such additives are also contemplated as part of the polyester composition.

In one aspect, the present disclosure relates to film(s) and sheet(s) and thermoformed or molded article(s) of this disclosure comprising the polyester and copolyester compositions useful in this disclosure. The methods of forming the polyester and copolyester compositions into film(s) and/or sheet(s) are well known in the art. Examples of film(s) and/or sheet(s) useful the present disclosure include but not are limited to extruded film(s) and/or sheet(s), compression molded film(s), calendered film(s) and/or sheet(s), solution casted film(s) and/or sheet(s). In one aspect, methods of making film and/or sheet useful to produce the film and sheet of the present disclosure include but are not limited to extrusion, compression molding, calendering, and solution casting.

In one embodiment, the polyester and copolyester compositions useful in this disclosure are made into film using any method known in the art to produce films from polyesters and copolyesters, for example, solution casting, extrusion, compression molding, or calendering.

In one embodiment, the polyesters useful in the present disclosure are made into films using any method known in the art to produce films from polyesters, for example, solution casting, extrusion, compression molding, or calendering.

In one embodiment of the present disclosure, the polyester and copolyester compositions can be formed by reacting the monomers by known methods for making polyesters and copolyesters in what is typically referred to as reactor grade compositions.

The thermoformed or molded articles can also be manufactured from any of the polyester or copolyester compositions disclosed herein.

In certain embodiments, the present disclosure includes but is not limited to thermoformed articles such as containers, plastic bottles, hot fill containers, and/or industrial articles or other applications.

In one aspect of the present disclosure, the disclosed polyester and copolyester compositions are useful as thermoformed and/or thermoformable film(s) or sheet(s). The present disclosure is also directed to articles of manufacture which incorporate the thermoformed film(s) and/or sheet(s) of this disclosure. In one embodiment, the polyesters compositions of the present disclosure are useful as films and sheets which are easily formed into shaped or molded articles. In one embodiment, the film(s) and/or sheet(s) of the present disclosure may be processed into molded articles or parts by thermoforming. The polyester and copolyester compositions of the present disclosure may be used in a variety of molding and extrusion applications.

One aspect of the present disclosure is a method of making molded or shaped parts and articles using thermoforming. Any thermoforming techniques or processes known to those skilled in the art may be used to produce the molded or shaped articles of this disclosure.

In one embodiment, the thermoforming processes can be done in several ways, for example as taught in “Technology of Thermoforming”; Throne, James; Hanser Publishers; 1996; pp. 16-29, which is incorporated herein by reference. In some embodiments, it is a positive thermoforming process where gas or air pressure is applied to the softened sheet, the sheet is then stretched and drawn out like a bubble and a male mold is brought into the bubble from the inside. Then vacuum is applied to further draw and conform the part to the male mold surface. In this thermoforming process biaxial stretching/orientation is done primarily in one step when there is a gas or air pressure applied to the softened sheet. The molding step is then completed with the vacuum and male mold to freeze the orientation into the sheet for a good balance of physical and appearance properties. In other embodiments, it is a negative thermoforming process where a vacuum or a physical plug is applied to the heat softened sheet and stretches and draws the sheet to nearly the final part size, and then, positive air pressure from the inside or further external vacuum from the outside draws and conforms the sheet against an outer, female mold, the orientation is frozen into the polymer and the sheet is formed into the article.

In other embodiments, thermoforming is a process where a film or sheet of the polyester compositions of the present disclosure are heated to a temperature sufficient to allow the deformation thereof, and the heated film or sheet is then made to conform to the contours of a mold by such means as vacuum assist, air pressure assist and matched mold assist. In another embodiment, the heated film or sheet is placed in a mold and forced to conform to the contours of the mold by, for example, application of air pressure, application of a vacuum, plug assist or application of a matching mold. In some embodiments, thermoforming produces thin wall articles.

In one embodiment, the thermoforming process molds the films or sheets into the desired shapes through the pressing of positive molds into the heated films or sheets. In this embodiment, thermoforming involves having a positive mold of an article supported between a vacuum-equipped surface or table. In this embodiment, heat from an external heat source such as a hot air blower, heat lamp or other radiant heat source is directed at the film or sheet. In this embodiment, the film or sheet is heated to the point of softening. In this embodiment, a vacuum is then applied to and below the table and around the mold, and the heat softened film or sheet is drawn toward the table, thus placing the softened film or sheet in contact with the mold surface. In this embodiment, the vacuum draws the softened film or sheet into tight contact with, and conformance to, the contours of the mold surface. As such, the film or sheet then assumes the shape of the mold. In this embodiment, after the film or sheet cools, it hardens, and the resulting article or part may be removed from the mold.

In one embodiment, the thermoforming process comprises: forming a film or sheet from the polyester compositions of the present disclosure; heating the film or sheet until it softens and positioning it over a mold; drawing the preheated film or sheet onto the heated mold surface; cooling the film or sheet; and then removing the molded article or part from the mold cavity, or optionally, heatsetting the formed film or sheet by maintaining the film or sheet in contact against the heated mold for a sufficient time period to partially crystallize the film or sheet.

In one embodiment, the thermoforming process comprising: forming a film or sheet from the polyester compositions of the present disclosure; heating a film or sheet to a temperature at or above the Tg of the polyester; applying gas, vacuum and/or physical pressure to the heat softened film or sheet and stretching the film or sheet to nearly the final part size; conforming the sheet by vacuum or pressure to a mold shape; cooling the film or sheet to a temperature below the Tg of the polyester; and then removing the thermoformed article or part from the mold.

The film and sheet used in the thermoforming process can be made by any conventional method known to those skilled in the art. In one embodiment, the sheet or film is formed by extrusion. In one embodiment, the sheet or film is formed by calendering. In one embodiment, during the thermoforming process the film or sheet is heated to a temperature at or above the Tg of the polyester. In one embodiment, this temperature is about 10 to about 60° C. above the Tg of the polyester. In one embodiment, the heating of the film or sheet prior to positioning over the thermoforming mold is necessary in order to achieve a shorter molding time. In one embodiment, the sheet must be heated above its Tg and below the point at which it sags excessively during positioning over the mold cavity. In one embodiment, before the molded film or sheet is removed from the mold it is allowed to cool to a temperature below the Tg of the polyester. In one embodiment, the thermoforming methods may include vacuum assist, air assist, mechanical plug assist or matched mold. In some embodiments, the mold is heated to a temperature at or above the Tg of the film or sheet. Selection of optimum mold temperature is dependent upon type of thermoforming equipment, configuration and wall thickness of article being molded and other factors.

In one embodiment, the heatset part can be removed from the mold cavity by known means for removal. For example, in one embodiment, blowback is used and it involves breaking the vacuum established between the mold and the formed film or sheet by the introduction of compressed air. In some embodiments, the molded article or part is subsequently trimmed and the scrap ground and recycled.

In some embodiments, the addition of nucleating agents provide faster crystallization during thermoforming and thus provide for faster molding. In one embodiment, nucleating agents such as fine particle size inorganic or organic materials may be used. For example, in one embodiment, suitable nucleating agents include talc, titanium dioxide, calcium carbonate, and immiscible or cross-linked polymers. In one embodiment, the nucleating agents are used in amounts varying from about 0.01% to about 20%, based on the weight of the article. In one embodiment, other conventional additives such as pigments, dyes, plasticizers, anti-cracking agent and stabilizers may be used as needed for thermoforming. In some embodiments, the anti-cracking agent improves impact strength, and the nucleating agent provides faster crystallization. In some embodiments, crystallization is necessary to achieve high temperature stability.

The compositions of this disclosure are useful as thermoformed articles or molded or shaped plastic parts or as solid plastic objects. The compositions of this disclosure are useful as thermoformed parts or articles. The compositions are suitable for use in any applications where clear, tough plastics are required.

The present thermoformed or thermoformable compositions are useful in forming films, molded articles, molded parts, shaped articles, shaped parts and sheeting. The methods of making the thermoformed or thermoformable compositions into films, molded articles, molded parts, shaped articles, shaped parts and sheeting can be according to any methods known in the art. Examples of molded articles include without limitation: face shields and masks, medical packaging, healthcare supplies, commercial foodservice products such as trays, containers, food pans, tumblers, storage boxes, bottles, utensils, water bottles, washing machine parts, refrigerator parts, vacuum cleaner parts, and toys.

This disclosure further relates to articles of manufacture comprising the film(s) and/or sheet(s) containing polyester compositions described herein. In embodiments, the films and/or sheets of the present disclosure can be of any thickness as required for the intended application.

This disclosure further relates to the film(s) and/or sheet(s) described herein. The methods of forming the polyester compositions into film(s) and/or sheet(s) includes any methods known in the art. Examples of film(s) and/or sheet(s) of the disclosure including but not limited to extruded film(s) and/or sheet(s), calendered film(s) and/or sheet(s), compression molded film(s) and/or sheet(s), solution casted film(s) and/or sheet(s). Methods of making film and/or sheet include but are not limited to extrusion, calendering, compression molding, and solution casting.

This disclosure further relates to the molded or shaped articles described herein. The methods of forming the polyester compositions into molded or shaped articles includes any known methods in the art. Examples of molded or shaped articles of this disclosure including but not limited to thermoformed or thermoformable articles, extrusion molded articles, and extrusion blow molded articles. Methods of making molded articles include but are not limited to thermoforming, extrusion, and extrusion blow molding. The processes of this disclosure can include any thermoforming processes known in the art. The processes of this disclosure can include any blow molding processes known in the art including, but not limited to, extrusion blow molding, extrusion stretch blow molding.

This disclosure includes any extrusion blow molding manufacturing process known in the art. Although not limited thereto, a typical description of extrusion blow molding manufacturing process involves: 1) melting the composition in an extruder; 2) extruding the molten composition through a die to form a tube of molten polymer (i.e. a parison); 3) clamping a mold having the desired finished shape around the parison; 4) blowing air into the parison, causing the extrudate to stretch and expand to fill the mold; 5) cooling the molded article; 6) ejecting the article of the mold; and 7) removing excess plastic (commonly referred to as flash) from the article.

1. A thermoformable article comprising a multilayer film or sheet comprising:
at least one layer (A1) which comprises a copolyester composition comprising a TMCD modified PET;
at least one layer (B) which comprises a polyester composition comprising PET or a slightly modified PET; and
optionally, at least one layer (A2) which comprises a copolyester composition comprising a TMCD modified PET; and
wherein the article is clear, hot-fillable, and recyclable (RIC-1).

2. The thermoformable article of claim 1, wherein the Tg of layer (A1) and layer (A2) copolyester compositions are about 100° C. or greater and the Tg of layer (B) polyester composition is from about 73° C. to about 83° C. as determined using a TA DSC 2920 from Thermal Analyst Instrument at a scan rate of 20° C./min.

3. A thermoformed article comprising a multilayer film or sheet comprising:
at least one layer (A1) which comprises a high Tg copolyester composition with a Tg greater than 100° C.;
at least one layer (B) which comprises a lower Tg polyester composition with a Tg less than 100° C.; and
optionally, at least one layer (A2) which comprises a high Tg copolyester composition with a Tg greater than 100° C.; and
wherein the article is clear and hot-fillable, and recyclable (RIC-1).

4. The thermoformable article of claim 1 or claim 3, wherein the copolyester composition of the at least one layer (A1), and optionally, the at least one layer (A2), and the at least one layer (B) comprises:
(a) a dicarboxylic acid component comprising:
(i) about 70 to about 100 mole% of terephthalic acid residues;
(ii) about 0 to about 30 mole% of aromatic and/or aliphatic dicarboxylic acid residues having up to 20 carbon atoms; and
(b) a diol component comprising:
(i) about 0 to about 100 mole % ethylene glycol (EG) residues;
(ii) about 0 to about 100 mole % 1,4-cyclohexanedimethanol (CHDM) residues;
(iii) about 0 to about 50 mole % 2,2,4,4-tetramethyl-1,3-cyclobutanediol (TMCD) residues;
(iv) about 0 to about 40 mole % 2,2-dimethylpropane-1,3-diol (neopentyl glycol or NPG) residues;
(v) about 0 to about 10 mole percent diethylene glycol (DEG) residues, whether or not formed in situ;
wherein the remainder of the glycol component comprises:
(vi) optionally, about 0 to about 10 mole% of the residues of at least one other modifying glycol;
wherein the total mole% of the dicarboxylic acid component is 100 mole%, and
wherein the total mole% of the glycol component is 100 mole%.

5. The article of claim 1 or claim 3, wherein the at least one layer (B) polyester composition comprising PET or a slightly modified PET comprises:
(a) a dicarboxylic acid component comprising:
(i) about 90 to about 100 mole% of terephthalic acid residues;
(ii) about 0 to about 10 mole% of aromatic and/or aliphatic dicarboxylic acid residues having up to 20 carbon atoms; and
(b) a diol component comprising:
(i) about 90 to about 100 mole % ethylene glycol (EG) residues
(ii) about 0 to about 10 mole % 1,4-cyclohexanedimethanol (CHDM) residues;
(ii) about 0 to about 10 mole % 2,2-dimethylpropane-1 ,3-diol (neopentyl glycol or NPG) residues
(iii) about 0 to about 10 mole % 2,2,4,4-tetramethyl-1 ,3-cyclobutanediol (TMCD) residues;
(iv) about 0 to about 10 mole percent diethylene glycol (DEG) residues, whether or not formed in situ;
wherein the remainder of the glycol component comprises:
(v) optionally, about 0 to about 10 mole% of the residues of at least one other modifying glycol;
wherein the total mole% of the dicarboxylic acid component is 100 mole%, and
wherein the total mole% of the glycol component is 100 mole%.

6. The thermoformable article of claim 1 or claim 3, wherein layer (A1) is about 3% to 30% of the article, layer (B) is about 70% to about 97% of the article, and optionally, layer (A2) is about 0% to about 15% of the article based on the total weight of the article; or wherein layer (A1) is about 5% to 20% of the article, layer (B) is about 80% to about 95% of the article, and optionally, layer (A2) is about 0% to about 10% of the article, based on the total weight of the article.

7. The thermoformable article of claim 1 or claim 3, wherein the multilayer film or sheet is clear or has haze values of about 3% or less, or 2% or less, or 1% or less.

8. The thermoformable article of claim 1, wherein the article is hot-fillable at temperatures of about 80° C. to 100° C. or is hot-fillable at temperatures of about 85° C. or less, or about 90° C. or less, or about 95° C. or less, or about 100° C. or less.

9. The thermoformable article of claim 1, wherein the article has a melt temperature of 225° C.-255° C. and is recyclable in a PET RIC-1 stream.

10. The thermoformable article of claim 1, wherein the article is reusable.

11. The thermoformable article of claim 1 or claim 3, wherein the article has a melt temperature of 225° C.-255° C.

12. The thermoformable article of claim 1, wherein the multilayer film or sheet has a thickness of greater than 3mil, or greater than 5mil, or 3mil to 25mil, or 5mil to 20mil.

13. The thermoformable article of claim 1, wherein the multilayer film or sheet is produced by co-extrusion, lamination, or a blown film process.

14. The thermoformed article of claim 1 or claim 3, wherein the article has a (A1)/(B) structure, (B)/(A1) structure , (A1)/(B)/(A1) structure, (A1)/(B)/(A2) structure (B)/(A1)/(B) structure, (A1)/(B)/(A1)/(B)/(A1) structure, (A1)/(B)/(A1)/(B)/(A2) structure or (A1)/(B)/(A2)/(B)/(A1) structure.

15. Medical packaging, form-filled sealed packaging, reusable packaging, face shields, healthcare supplies, commercial foodservice products, residential foodservice products, blenders, consumer appliances, consumer electronics devices, automotive parts, cosmetics packaging, trays, containers, food pans, tumblers, cups, storage boxes, bottles, water bottles, washing machine parts, refrigerator parts, vacuum cleaner parts, or toys comprising the multilayer thermoformed article of claim 1
.

16. A method of making the multilayer thermoformed article of claim 1 comprising: 1) heating the multilayer film or sheet; 2) applying gas, vacuum and/or physical pressure to the heat softened multilayer film or sheet; 3) conforming the multilayer film or sheet by vacuum or pressure to a mold shape; 4) removing the thermoformed part or article from the mold.

17. The method of claim 16, wherein said multilayer film or sheet is formed by co-extrusion or lamination.

18. The method of claim 16, wherein the inherent viscosity of the multilayer film or sheet is from about 0.50 to about 1.20 dL/g as determined in 60/40 (wt/wt) phenol/ tetrachloroethane at a concentration of 0.25 g/50 ml at 25° C.
